(19) United States
(12) Patent Application Publication
(10) Pub. No.: US 2024/0167180 A1
(43) Pub. Date: May 23, 2024

(54) Method for Treating Process Fluids, and Filter Device for Carrying Out the Method

(71) Applicant: HYDAC International GmbH, Sulzbach / Saar (DE)

(72) Inventor: Sebastian König, St. Ingbert (DE)

(73) Assignee: HYDAC International GmbH, Sulzbach / Saar (DE)

(21) Appl. No.: 18/551,550

(22) PCT Filed: Mar. 9, 2022
(86) PCT No.: PCT/EP2022/056041

§ 371 Date: Sep. 20, 2023

(30) Foreign Application Priority Data
Mar. 27, 2021 (DE) 10 2021 001 631.9

(51) Int. Cl. C25B 15/08; B01D 19/00; B01D 27/00; C25B 1/04; C25B 9/23

(52) U.S. Cl. CPC C25B 15/085; B01D 19/0031; B01D 27/00; C25B 1/04; C25B 9/23; C25B 15/083

(57) ABSTRACT

The invention relates to a method for treating process fluids, such as those which are produced when a process liquid is separated into different process gases using an electric current in an electrolysis cell (10), comprising at least one fluid circuit in which at least one of the process gases is contained in the process liquid, thereby forming the process fluid, wherein at least one fluid storage tank (22) is provided as part of the fluid circuit. The invention is characterized in that the fluid storage tank (22) is equipped with at least one filter device (24), by means of which the process fluid is cleaned of any possible particulate contamination and simultaneously the contained process gas is separated from the process fluid while the process liquid is retained.

### CROSS-REFERENCE TO RELATED APPLICATIONS

This application claims priority to German Patent Application No. DE 10 2021 001 631.9, filed on Mar. 27, 2021 with the German Patent and Trademark Office. The contents of the aforesaid Patent Application are incorporated herein for all purposes.

### TECHNICAL FIELD

The invention relates to a method for treating process fluids, such as those which are produced when a process liquid is separated into different process gases using an electric current in an electrolysis cell, comprising at least one fluid circuit in which at least one of the process gases is contained in the process liquid, thereby forming the process fluid, wherein at least one fluid storage tank is provided as part of the fluid circuit. The invention also relates to a device for carrying out the method.

### BACKGROUND

This background section is provided for the purpose of generally describing the context of the disclosure. Work of the presently named inventor(s), to the extent the work is described in this background section, as well as aspects of the description that may not otherwise qualify as prior art at the time of filing, are neither expressly nor impliedly admitted as prior art against the present disclosure.

WO 2011/012507 A1 discloses a method and a device for producing hydrogen and oxygen, wherein, in particular, the excess electrical energy from wind turbines can be used for this purpose. The associated device for carrying out the method uses a reversible polymer electrolyte membrane fuel cell (PEMFC) with a proton exchange membrane (PEM) as the electrolyser. By reversing the fuel cell process, such a fuel cell can also be used to produce hydrogen on the one hand and oxygen on the other hand as the different process gases from water as the process liquid. The fuel cell then acts as an electrolyser and must be supplied with electrical power, wherein it is also possible to combine a plurality of fuel cells as a fuel cell stack. The current required for this purpose may, for example, originate from generators connected to wind turbines. The electrolysis apparatus usually used in the form of electrolysis cells to produce hydrogen and oxygen are the kind that are generally operated at atmospheric pressure or in connection with pressure electrolysis. The proton exchange membrane of the described reversible fuel cell separates a negative side from a positive side. Due to the electrolysis that takes place in the reversible fuel cell when current is applied, a water molecule is divided into hydrogen and oxygen on the positive or anode side respectively, wherein the hydrogen, as a proton, moves through the proton exchange membrane to the negative or cathode side respectively, whereas the oxygen remains on the positive side.

For the associated reaction to take place, water must be present on the positive side as the process liquid, the respective water supply being provided by an independent circuit. The water used as the process liquid is actually pure water and is accordingly, wherever possible, provided without any foreign substances. The amount of water required within the circuit supply is not only dependent on the amount of water needed for the electrolysis reaction (9 kg water is generally required to produce 1 kg hydrogen), but also on the cooling requirements of the electrolysis cell, or the electrolysis cell stack respectively, as the process water simultaneously acts as a cooling medium for the electrolysis operation. As such, each PEM electrolysis operation generally has a water circuit on the positive or oxygen side respectively.

The oxygen produced as the process gas dissolves and is mixed with water as the process liquid which is supplied in the associated supply circuit, thereby forming a process fluid. In this process, gas bubbles of varying sizes are carried along in the water circuit in the form of oxygen and a so-called gravity separator is connected downstream of the associated water circuit, said gravity separator usually consisting of a fluid storage tank with a horizontal orientation, said tank being designed to have a large volume and the process fluid, water with the dissolved oxygen, flowing into said tank. Sufficient time is allowed for the process gas, oxygen, to be degassed from the process fluid in the storage tank in order to recover pure water as the process liquid. By virtue of the fact that large-volume fluid storage tanks with a horizontal orientation are used, a large fluid surface area is provided as a fluid level in the tank to enable the process gas to be degassed effectively. Although it is desirable to once again obtain pure water as the process liquid after degassing the process fluid, the apparatus used, and, for example, the way the pipes are routed, may mean that particles inadvertently enter the process liquid and contaminate it accordingly, also leading to a residual content of incompletely degassed process gas, which may be regarded as being of questionable use for readmission to the sensitive electrolysis cell or electrolysis cell stack.

### SUMMARY

A need exists to provide an improved method and device to help facilitate the degassing process for a process gas while simultaneously keeping the process liquid clean for renewed use in electrolysis cell operation. The need is addressed by a method and a filter device according to the independent claims. Embodiments of the invention are described in the dependent claims, the following description, and the drawings.

### BRIEF DESCRIPTION OF THE DRAWINGS

FIG. 1 shows an electrolysis process including degassing using an example outline flowchart in a highly schematic, simplified form;

FIGS. 2 and 3 each show perspective views, one as a plan view and the other as a longitudinal view, of an example filter device used in the flowchart shown in FIG. 1.

### DESCRIPTION

The details of one or more embodiments are set forth in the accompanying drawings and the description below. Other features will be apparent from the description, drawings, and from the claims.

In the following description of embodiments of the invention, specific details are described in order to provide a thorough understanding of the invention. However, it will be apparent to one of ordinary skill in the art that the invention may be practiced without these specific details. In other instances, well-known features have not been described in detail to avoid unnecessarily complicating the instant description.

In some embodiments, a method for treating process fluids is provided, using a fluid storage tank, which is equipped with at least one filter device, by means of which the process fluid is cleaned of any possible particulate contamination and simultaneously the dissolved process gas is separated from the process fluid while the process liquid is retained. As such, the method using the filter device ensures that even finely dispersed process gas in the process fluid can be discharged to the gas side of the fluid storage tank, wherein gas bubbles with a small volume are merged together due to surface tension to form larger gas bubbles, making it easier for them to be discharged from the process fluid. The process fluid, which is cleaned by the filter device of any particulate contamination such that it is very pure, remains behind on the liquid side of the fluid storage tank for a further extraction process in electrolysis cell operation. This therefore has no parallel in the prior art. As such, degassing of process water on the oxygen side of PEM electrolysers in a fluid storage tank is ensured. In particular, it is possible to remove the smallest gas bubbles from the fluid by means of a filter medium in the filter device which is suitable for this purpose. As such, even the smallest gas bubbles, which might otherwise accumulate in the process liquid, are effectively removed. Thus, where the claims mention that at least one process gas is contained in the process liquid, this means a loose connection between the gas and liquid, in which the gas is carried with the liquid without being bonded thereto, for example is carried along with the fluid flow; however, this also means that the gas is at least partially present in the liquid in dissolved form, for example in a finely dispersed form.

In process engineering terms it is not necessary for an additional liquid circuit to be used on the negative side as part of hydrogen production. The hydrogen atoms (protons) which reach the negative side as part of electrolysis cell operation do, admittedly, always carry a few water molecules along with them as a general rule; however, in theory, the negative side of a PEM electrolysis process may be run ‘dry’, i.e., no independent liquid circuit is provided on the cathode side.

However, the negative or cathode side may also be operated as part of a liquid circuit, which is independent of the liquid circuit on the oxygen side. This allows for more uniform cooling and the water is able to discharge the hydrogen satisfactorily from the electrolysis cell. The aforementioned method can therefore also be used alongside the device for degassing process water on the hydrogen side of PEM electrolysers. In this process, the hydrogen, in the form of gas bubbles, is in turn carried along in more or less dissolved form by the process water as process fluid and conveyed to an independent fluid storage tank, where the hydrogen can then be degassed by means of the filter device.

In addition to the disclosed PEM electrolysis method, it is also possible to use alkaline electrolysis to obtain hydrogen and oxygen gas, in which case a so-called diaphragm is used as a separating element instead of a proton exchange membrane, said diaphragm generally consisting of a fine metallic grid structure. In this case, the actual electrolysis reaction now takes place on the negative side, on which the produced hydrogen remains and only the resulting oxygen moves through the diaphragm as a so-called hydroxide molecule onto the positive side, where it recombines with electrons to form oxygen. To ensure that the aforementioned process works, sufficient hydroxide ions must be present in the process liquid. This can be achieved by using a caustic potash solution, for example a 30% caustic potash solution, instead of pure water. This contains a great many of the necessary ions and thus ensures good conductivity and therefore a very efficient electrolysis process. To ensure that the hydroxide irons can recombine to form oxygen on the positive side, they must be able to almost float in the liquid until they reach the positive electrode or anode. In alkaline electrolysis with a diaphragm, therefore, it is not, as a general rule, possible for hydrogen to work with electrodes without its own liquid circuit, as in the case of PEM electrolysis; instead, there are two liquid circuits: one on the oxygen side and one on the hydrogen side. Instead of a diaphragm, a so-called anion exchange membrane (AEM) can also be used with comparable results. In the same way as PEM electrolysis, alkaline systems with AEM instead of a diaphragm can also be designed without their own fluid circuit using a ‘dry’ hydrogen side.

Both liquid circuits once again contain fluid storage tanks downstream of the electrolysis cell stack, in which tanks the liquid can be released of oxygen on the positive side and hydrogen on the negative side by means of the filter device used in each case. The two process gases are once again transported from the liquids from the respective cells as gas bubbles of varying sizes and, by creating two separate liquid circuits, each with a fluid storage tank as well as a filter device arranged therein, this results in an accelerated degassing process and a highly pure process liquid, cleaned of particulate contamination and gas bubbles, is then once again provided in the respective liquid circuit for the actual electrolysis cell operation. As such, degassing of the electrolyte liquid (caustic potash solution) on both the oxygen side and on the hydrogen side of alkaline electrolysers is therefore ensured.

The filter device used to carry out the method comprises a for example exchangeable filter element through which the process fluid can flow from the inside to the outside, wherein the filter element is surrounded by a housing wall while in each case retaining a pre-definable radial distance and forming a fluid flow chamber, said housing wall being formed as a discharge pipe and comprising a plurality of through points, some of which are arranged beneath the respective variable fluid level in the fluid storage tank, while the remainder are arranged above said fluid level. However, it is also possible to achieve an effective bubble discharge via the respective filter medium without an additional housing wall.

To ensure an improved gas separation operation, it is proposed that the respective through points are formed in a window-like manner in the housing wall of the filter device. The gas bubbles gather at the edges of the housing wall at these particularly window-like through points and individual gas bubbles increase in size with respect to their gas volume such that they have increased buoyancy and are separated from the process fluid in real time. Although a discharge close to the fluid level takes place in the fluid storage tank along the surface of the process liquid, this does not cause foaming of said liquid, with the result that undisrupted extraction of fluid the process for further electrolysis cell operation is possible. If the gradient of the filter medium is designed accordingly, it is possible to achieve improved bubble discharge from the fluid even on the hollow-cylindrical inside of the filter element.

In some embodiments, the filter device may be fixed inside the fluid storage tank by means of its lid part, wherein the inflow for the process fluid takes place inside the filter element from the opposite bottom housing wall of the fluid storage tank. A plurality of such filter devices may also be accommodated in one fluid storage tank if required and a used filter element may be replaced with a new element by releasing through the lid part.

Due to the reduced stay time in the fluid storage tanks, said tanks can be reduced in volume, which is referred to in technical terminology as downsizing. As such, the container costs for the tank can be reduced and, in addition, the gas chamber lying above the fluid level in the tanks can be reduced such that there is less dead volume, thus increasing the dynamics of the entire system. Accordingly, less process fluid, such as water or caustic potash solution, is also required, improving the so-called cold start behaviour in electrolysis cell operation.

At least one smaller gas chamber on the hydrogen discharge side is helpful for safety reasons as hydrogen is known to be highly flammable, particularly when combined with oxygen in the air, leading to the formation of so-called explosive gases. As such, in real life, some hydrogen is also always dispersed through the respective membrane (PEM or AEM) or the diaphragm onto the oxygen side, which, in a partial load range of electrolysis cell operation can lead to such an explosive gas mixture arising on the oxygen side. A smaller gas volume in the fluid storage tank on the oxygen side is also definitely helpful in this respect.

Reference will now be made to the drawings in which the various elements of embodiments will be given numerical designations and in which further embodiments will be discussed.

Specific references to components, process steps, and other elements are not intended to be limiting. Further, it is understood that like parts bear the same or similar reference numerals when referring to alternate FIGS.

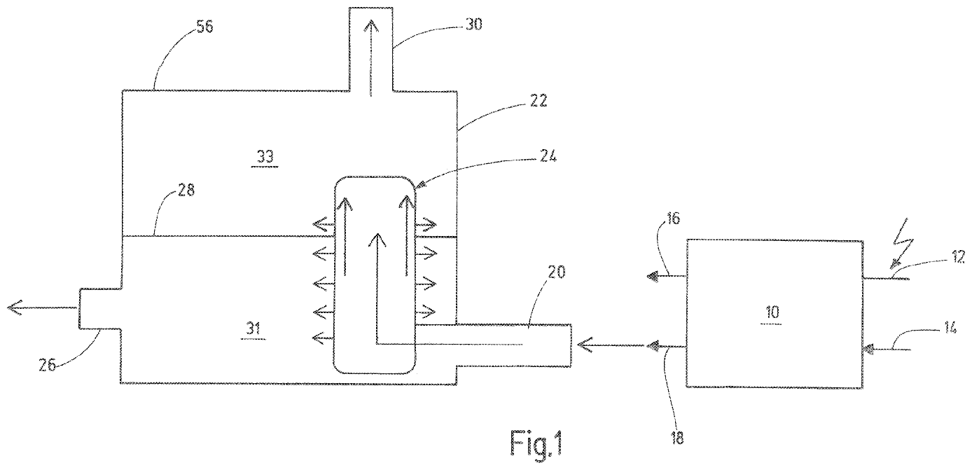

FIG. 1 shows an electrolysis cell or an electrolysis cell stack referred to in its entirety as 10 in the form of a black box representation. The electrolysis cell 10 is connected via a power cable 12 to a power source (not shown) such as for example to the generator of a wind turbine. Furthermore, the electrolysis cell 10 comprises a supply line 14 for a process liquid in the form of water or a caustic potash solution. The cooling circuit for the electrolysis cell 10 is omitted for ease of representation.

During operation of the cell 10, said cell separates the process liquid, water, into hydrogen and oxygen by means of the electric current and by using a proton exchange membrane (not shown), wherein the hydrogen is removed via a hydrogen line 16 and the oxygen dissolved or alternatively finely dispersed in the process liquid, said oxygen also being carried along in the flow, is removed from the electrolysis cell 10 as a process fluid via the discharge line 18. The discharge line 18 is connected in a fluid-conveying manner to an inlet 20 of a fluid storage tank 22, which receives a filter device referred to in its entirety as 24. The fluid storage tank 22 also has an outlet 26 located beneath a fluid level 26 and a further outlet 30 for the process gas, oxygen, at the top. The fluid outlet 28 for process liquid is connected to the supply line 14, forming a circuit supply (not shown), in order to obtain accordingly cleaned process liquid for operation of the electrolysis cell. By means of the filter device 24, the process fluid (water and oxygen) present at the inlet 20 is cleaned of any particulate contamination and at the same time the dissolved process gas, oxygen, is separated out of the process fluid while retaining the process fluid, water. The accordingly cleaned process water is then returned from the liquid side 31 of the tank 22 via the outlet 26 and the separated gas leaves the fluid storage tank 22 in the form of oxygen via the gas side 33 of said tank and via the further outlet 30 at the top. As is also shown in FIG. 1 in particular, the degassing and cleaning process is controlled in such a way that the fluid level 28 in the fluid storage tank 22 only partially covers the filter device 24 such that the filter device 24 protrudes over the fluid level 28 with a pre-definable axial structural length.

If, contrary to the representation in FIG. 1, the hydrogen electrode is not operated ‘dry’ without its own fluid circuit, but rather as a so-called wet electrode with its own liquid circuit, a corresponding post-treatment apparatus may be connected to the hydrogen line 16, said apparatus consisting of components, namely the fluid storage tank 22 and filter device 24.

Furthermore, instead of using water as a process liquid, caustic potash solution can be used, in which case this is supplied via the supply line 14 for the electrolysis cell 10. Accordingly, oxygen is then separated via the line 18 and hydrogen via the line 16. A diaphragm, which is not shown in any greater detail, serves as a separating element in the cell 10, for example in the form of a fine metal grid or an anion exchange membrane. In this case, both liquid circuits on both the oxygen and on the hydrogen side are then equipped with a post-treatment apparatus as shown in FIG. 1.

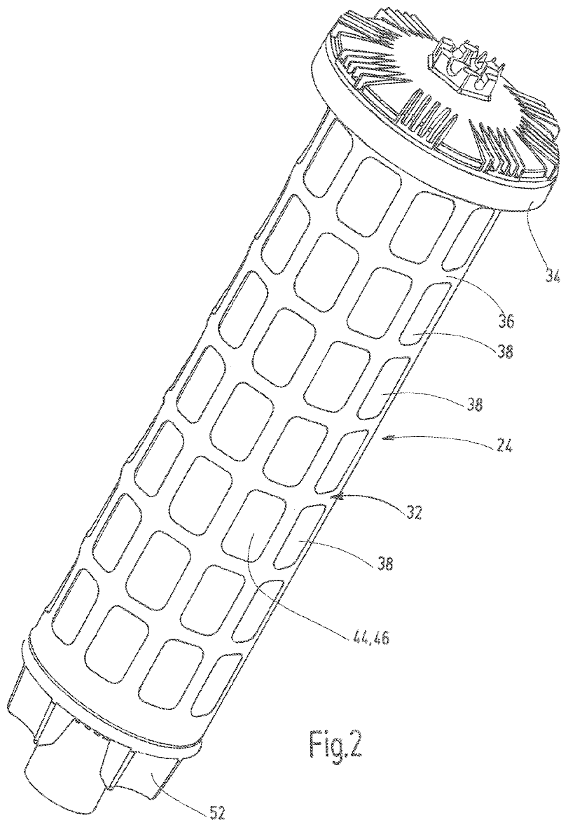

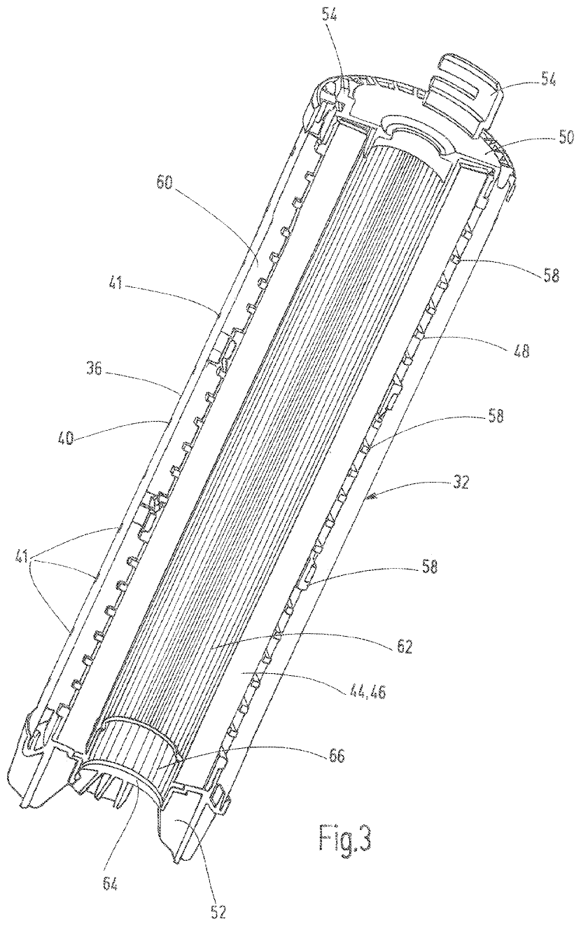

The filter device shown in FIGS. 2 and 3 is particularly important for the cleaning and degassing operations. The filter device designed as a so-called in-tank solution is shown in its entirety in FIGS. 2 and 3 and comprises a filter housing referred to in its entirety as 32, which comprises a lid part 34 on the top and also a housing wall 36, which is designed as a kind of discharge pipe. The housing wall 36 comprises fluid passages in the form of windows 38 (FIG. 2), wherein, instead of the window-like through points 38, a perforation 40 shown in FIG. 3 can also be accommodated in the housing wall 36. The corresponding perforation 40 consists of individual circular holes 41 in the housing wall 36, for example in the form of through holes. Instead of the illustrated filter device, a different kind of filter device can also be used, which carries out the gas separation exclusively via the filter medium, also on its inside and does so entirely without a housing wall with through windows.

FIG. 3 shows the part of the filter housing 32 that extends from the lid part 34 into the inside of the fluid storage tank 22 and consists of a structural unit formed by a filter element 44 as an integral part of the discharge pipe 36. The filter element 44 comprises, as usual, a hollow-cylindrical element material 46 which extends together with an external support tube 48, which is equipped with fluid passage points, between an upper end cap 50 and a lower end cap 52. The upper end cap 50 assigned to the lid part 34 can be connected to the lid part 34 by means of individual latching webs 54. The lid part 34 can be connected to the upper side 56 of the storage tank 22 such that it can be detached again by means of a threaded part which is not shown in greater detail. The support tube 48 comprising fluid passages is formed by individual partial segments 58 of longitudinal and transverse rods, said segments being latched to one another, and the housing wall 36, which is equipped with passages 38, 41, surrounds the filter element 44 with its support tube 48 at a pre-definable radial distance such that a fluid flow chamber 60 is formed therebetween.

FIG. 3 also shows the configuration of the lower end cap 52 via which process fluid can pass into the inner filter cavity 62 for filtration and degassing operation, for which purpose the lower end cap 52 is equipped with a central mid-opening 64. Contrary to the outline representation in FIG. 1, the fluid admission therefore takes place via an inlet, which does not pass through the sides of the tank wall of the storage tank 22, but engages from below via a base inlet opening, which is not shown in further detail, which passes into the inside of the filter device in the form of a nozzle, and is surrounded by an enclosure 66 with an upper end stop.

The respective process fluid thus flows via the lower mid-opening 64 into the filter cavity 62 and then passes through the element material 46 of the filter element 44 from the inside to the outside. In this operation, the process fluid is cleaned of contamination, particularly in the form of particulate contamination and small gas bubbles finely dispersed or carried along in the fluid, and passes via the fluid flow chamber 60 after passing through the window-like through openings 38 (FIG. 2) or the hole-like perforation 40 (FIG. 3) in the associated housing wall 36 to the inside of the tank 22 such that cleaned process fluid passes in this way to the filtrate side of the filter device and thus to the liquid side 31 of the fluid storage tank 22 with a variable fluid level 28.

In this process, gas bubbles accumulate at the respective through opening 38, 40 in the housing wall 36, said gas bubbles merging to form larger bubble clusters which then rise up on the outside of the housing wall 36 and reach the gas side 33 of the storage tank 22, with the option to be discharged from the tank 22 by means of the further outlet 30 on the gas side.

In order to replace the filter element 44 with a new element, the lid part 34 can thus then be screwed off the tank 22 on the upper side 56 thereof and the unit shown in FIG. 3 can be removed from the tank 22 together with the lid part 34. After separating the lid part 34 via the latching webs 54 from the other parts of the filter device, the filter element 44 can be removed from the filter housing 32 via the upper discharge opening and replaced with a new element. In a correspondingly reverse sequence, the filter device can then be reinserted in the tank 22. While particle filtration takes place substantially horizontally in a throughflow direction (FIG. 1), degassing takes place in a vertical direction along the inside and outside of the housing wall 36, wherein any entrained fluid is able to run down due to gravity and contributes to increasing the fluid level 28 in the tank 22. As such, by means of the filter device 24, degassing of hydrogen or oxygen respectively from process fluids as part of electrolysis cell operation is made significantly easier, wherein the associated device can also be used without any problem for alkaline electrolysis. The method described here and the filter device can also readily be used for other electrolysis methods, e.g., for chlorine production.

The invention has been described in the preceding using various exemplary embodiments. Other variations to the disclosed embodiments may be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor, module or other unit or device may fulfil the functions of several items recited in the claims.

The term “exemplary” used throughout the specification means “serving as an example, instance, or exemplification” and does not mean “preferred” or “having advantages” over other embodiments. The term “in particular” and “particularly” used throughout the specification means “for example” or “for instance”.

The mere fact that certain measures are recited in mutually different dependent claims or embodiments does not indicate that a combination of these measures cannot be used to advantage. Any reference signs in the claims should not be construed as limiting the scope.

What is claimed is:

1-9. (canceled)

10. A method for treating process fluids, such as those which are produced when a process liquid is separated into different process gases using an electric current in an electrolysis cell, having at least one fluid circuit in which at least one of the process gases is contained in the process liquid, thereby forming the process fluid, wherein at least one fluid storage tank is provided as part of the fluid circuit, wherein the fluid storage tank is equipped with at least one filter device, comprising:
cleaning the process fluid of particulate contamination; and
simultaneously separating the contained process gas from the process fluid while the process liquid is retained.

11. The method of claim 10, wherein water or caustic potash solution is used as the process liquid and hydrogen and oxygen are produced as process gases.

12. The method of claim 10, wherein at least one proton exchange membrane is used as a separating element to produce process gases using water as the process liquid, and wherein the process fluid arising on the oxygen side of the membrane is separated back into its constituent parts, water and oxygen, using the filter device arranged in the storage tank.

13. The method of claim 10, wherein the hydrogen arising on the hydrogen side of the proton exchange membrane is dissolved in water as the process liquid, thereby forming the process fluid and is separated back into its constituent parts, water and hydrogen, using the filter device.

14. The method of claim 10, wherein, to produce process gases, at least one diaphragm or one anion exchange membrane is used as the separating element, using caustic potash solution as the process liquid, and wherein the process fluid arising on the oxygen side and the hydrogen side of the diaphragm is separated using an assignable filter device in the storage tank back into its constituent parts, caustic potash solution and to the respective process gas in the form of oxygen and hydrogen.

15. A filter device for treating process fluids having at least one filter element, through which a fluid can flow from the inside to the outside, wherein the filter element is surrounded by a housing wall while retaining a pre-definable radial distance and forming a fluid flow chamber, said housing wall being formed as a discharge pipe and comprising a plurality of through points, some of which are arranged beneath the respective variable fluid level in the fluid storage tank, while the remainder are arranged above said fluid level.

16. The filter device of claim 15, wherein the respective through points in the housing wall are designed to be window-like, wherein gas bubbles located in the cleaned fluid can be separated via the window-like through openings and collected for discharge close to the fluid level.

17. The filter device of claim 16, wherein the housing wall having the window-like through openings can be fixed by a lid part in the fluid storage tank, wherein a supply of process fluid into the inside of the filter element is provided via an inlet in the fluid storage tank.

18. The filter device of claim 15, wherein opening cross-sections for the through points are configured such that the volume of the gas bubbles can be increased to facilitate discharge under the influence of their surface tension.

19. The method of claim 11, wherein at least one proton exchange membrane is used as a separating element to produce process gases using water as the process liquid, and wherein the process fluid arising on the oxygen side of the membrane is separated back into its constituent parts, water and oxygen, using the filter device arranged in the storage tank.

20. The method of claim 11, wherein the hydrogen arising on the hydrogen side of the proton exchange membrane is dissolved in water as the process liquid, thereby forming the process fluid and is separated back into its constituent parts, water and hydrogen, using the filter device.

21. The method of claim 12, wherein the hydrogen arising on the hydrogen side of the proton exchange membrane is dissolved in water as the process liquid, thereby forming the process fluid and is separated back into its constituent parts, water and hydrogen, using the filter device.

22. The method of claim 11, wherein, to produce process gases, at least one diaphragm or one anion exchange membrane is used as the separating element, using caustic potash solution as the process liquid, and wherein the process fluid arising on the oxygen side and the hydrogen side of the diaphragm is separated using an assignable filter device in the storage tank back into its constituent parts, caustic potash solution and to the respective process gas in the form of oxygen and hydrogen.

23. The method of claim 12, wherein, to produce process gases, at least one diaphragm or one anion exchange membrane is used as the separating element, using caustic potash solution as the process liquid, and wherein the process fluid arising on the oxygen side and the hydrogen side of the diaphragm is separated using an assignable filter device in the storage tank back into its constituent parts, caustic potash solution and to the respective process gas in the form of oxygen and hydrogen.

24. The method of claim 13, wherein, to produce process gases, at least one diaphragm or one anion exchange membrane is used as the separating element, using caustic potash solution as the process liquid, and wherein the process fluid arising on the oxygen side and the hydrogen side of the diaphragm is separated using an assignable filter device in the storage tank back into its constituent parts, caustic potash solution and to the respective process gas in the form of oxygen and hydrogen.

25. The filter device of claim 14, wherein the filter element is configured to be exchangeable.

26. The filter device of claim 16, wherein opening cross-sections for the through points are configured such that the volume of the gas bubbles can be increased to facilitate discharge under the influence of their surface tension.

27. The filter device of claim 17, wherein opening cross-sections for the through points are configured such that the volume of the gas bubbles can be increased to facilitate discharge under the influence of their surface tension.
